(19) United States
(12) Patent Application Publication
(10) Pub. No.: US 2010/0322236 A1
(43) Pub. Date: Dec. 23, 2010

(54) METHOD AND APPARATUS FOR MESSAGE ROUTING BETWEEN CLUSTERS USING PROXY CHANNELS

(75) Inventors: Markku Kalevi Vimpari, Oulu (FI); Petri Tapan Liimatta, Oulu (FI); Matti Juhani Oikarinen, Oulu (FI); Juha Petri Hartikainen, Oulu (FI); Tero Mikael Halla-Aho, Oulu (FI); Kristain Andreas Luoma, Kiviniemi (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/487,192

(22) Filed: Jun. 18, 2009

(51) Int. Cl. H04L 12/56

(52) U.S. Cl. 370/389

(57) ABSTRACT

An approach is provided for message routing among clusters via a proxy channel. A subscription request is received from a node within a local cluster. The subscription request is for a service. It is determined that the service is provided by a remote cluster. A transmission of the subscription request to a service platform of the remote cluster is initiated. The service is provided to the node via a proxy channel.

### BACKGROUND

Service providers and device manufacturers are continually challenged to deliver value and convenience to consumers by, for example, providing compelling network services. Important differentiators in the industry are application and network services as well as capabilities to support and scale these services. In particular, communications from clients to services can be optimized to scale geographically. Geographic scaling, however, leads to new distribution problems.

### SOME EXAMPLE EMBODIMENTS

According to one embodiment, a method comprises receiving a subscription request to a service from a node within a local cluster. The method also comprises determining that the service is provided by a remote cluster. The method further comprises initiating transmission of the subscription request to a service platform of the remote cluster. The method also further comprises providing the service to the node via a proxy channel.

According to another embodiment, an apparatus comprising at least one processor, and at least one memory including computer program code, the at least one memory and the computer program code configured to, with the at least one processor, cause the apparatus to receive a subscription request to a service from a node within a local cluster. The apparatus is also caused to determine that the service is provided by a remote cluster. The apparatus is further caused to initiate transmission of the subscription request to a service platform of the remote cluster. The apparatus is also further caused to provide the service to the node via a proxy channel.

According to another embodiment, a computer-readable storage medium carrying one or more sequences of one or more instructions which, when executed by one or more processors, cause an apparatus to receive a subscription request to a service from a node within a local cluster. The apparatus is also caused to determine that the service is provided by a remote cluster. The apparatus is further caused to initiate transmission of the subscription request to a service platform of the remote cluster. The apparatus is also further caused to provide the service to the node via a proxy channel.

According to another embodiment, an apparatus comprises means for receiving a subscription request to a service from a node within a local cluster. The apparatus also comprises means for determining that the service is provided by a remote cluster. The apparatus further comprises means for initiating transmission of the subscription request to a service platform of the remote cluster. The apparatus also further comprises means for providing the service to the node via a proxy channel.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIGS. 1A and 1B are diagrams of a messaging system capable of distributing messages to services, according to various embodiments;

FIG. 2 is a diagram of the components of messaging buses within user equipment and services platform, according to one embodiment;

FIG. 3 is a flowchart of a process for efficiently distributing messages to subscribers in multiple geographic locations, according to one embodiment;

FIG. 4. is a ladder diagram for processes for subscribing endpoints for distributing messages to a multitude of endpoints via clusters in multiple geographic locations, according to one embodiment;

FIG. 5. is a ladder diagram for processes of sending messages to multiple users via clusters in multiple geographic locations, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile station (e.g., handset) that can be used to implement an embodiment of the invention.

### DESCRIPTION OF PREFERRED EMBODIMENT

A method, apparatus, and software for delivering messages via a proxy channel are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

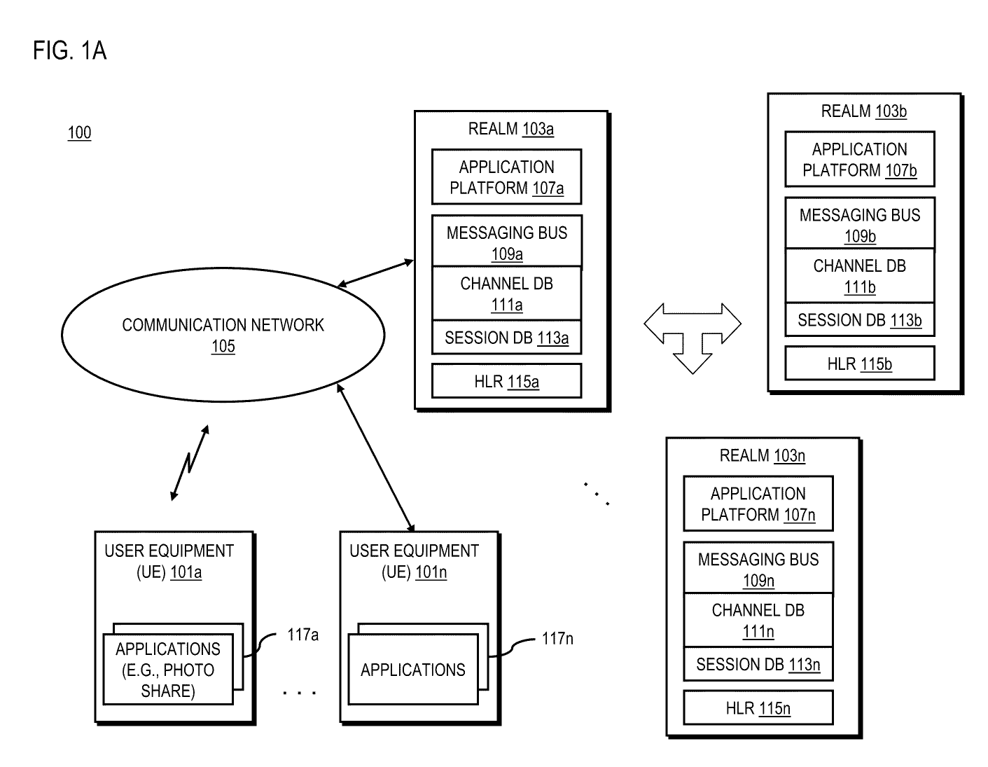

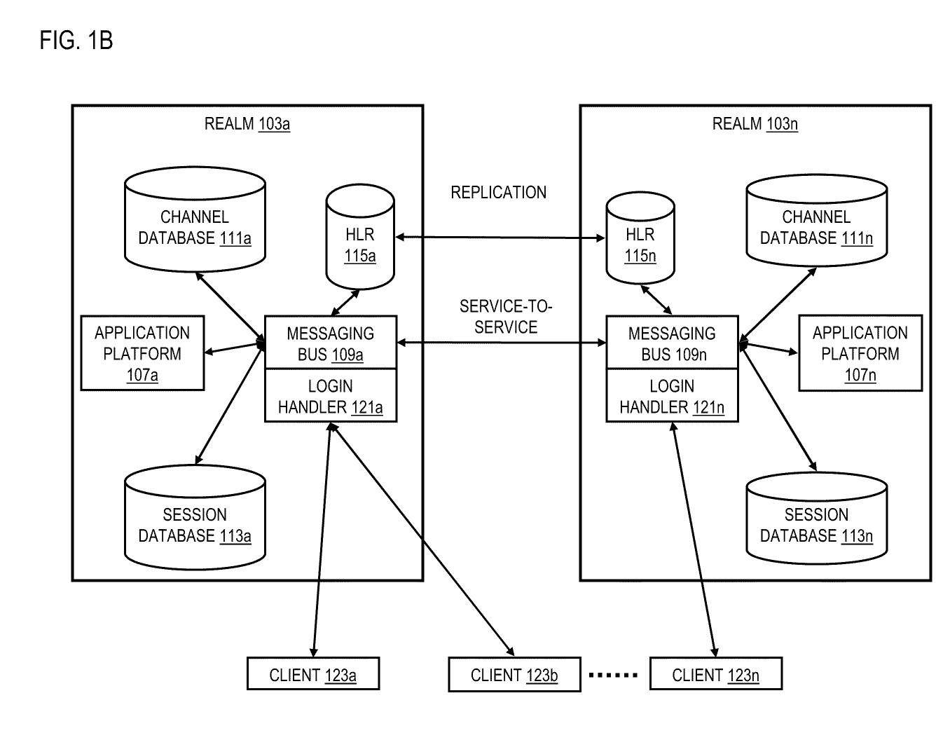

FIGS. 1A and 1B are diagrams of a messaging system capable of distributing messages to services, according to various embodiments. For purposes of illustration, system 100 provides for the efficiency of publishing and subscribing to communication services on a node, e.g., user equipment (UE) 101. As shown in FIG. 1A, system 100 comprises one or more user equipment, e.g., UEs 101a-101n, having connectivity to realms 103a-103n via a communication network 105. A realm 103 can be a geographically separated service site. The UEs 101 can connect to application platforms 107a-107n through this connection via a messaging bus 109a-109n, a channel database 111a-111n, a session database 113a-113n, and a home location registry (i.e., home locator) 115a-115n. According to certain embodiments, the application platforms 107 provide a number of services, which can include, for instance, mobile maps, music downloads, mobile games, photo sharing, file storage, synchronization of files with desktop computers, messaging etc. UE 101 applications 117 can utilize these services. Other applications and services can provide access to calendar and files wherever a user is, whether by mobile device, Internet café, or a home personal computer (PC). These applications and services can be optimized to communicate with additional applications and services in a way that can scale geographically through the use of a geographically distributed messaging bus 109.

In one embodiment, system 100, is a geographically distributed messaging system for distributing data via a message bus 109. The geographical distribution allows for scalability of sending messages to many users quickly via a messaging bus 109. The messaging bus 109 is capable of multiple communication methods (e.g., publish-subscribe messaging, point-to-point messaging, etc.). Thus, multiple subsystems are deployed at different realms 103. In one embodiment, a home location can be a cluster within a realm 103. Home location information can also include a node associated with a home cluster. A cluster can be a group of linked computers acting to process information similar to a single computer. A node can be a computer or other UE 101 being serviced by a cluster. In some embodiments, a cluster is a realm 103. Each realm 103 should be able to communicate with other realms 103 to exchange messages between different end-points (e.g., users or services) located in different realms 103. In one embodiment, a message can be multicast to multiple endpoints in multiple regions via clusters servicing those regions. Multicasting provides efficient delivery of information by creating copies of the information only when the destination endpoints diverge, such that, in general, common paths contain only one copy of the information. In this manner, a message can be sent from a data producer at one cluster to a multitude of endpoints serviced by the cluster or other clusters associated with the messaging system, whereby the link between the clusters carries a single copy of the content. A data producer's cluster could send copies of the message to each endpoint within the same cluster. In an improved embodiment, the data producer's cluster sends a single copy of the message to each intended endpoint's cluster. The endpoint's cluster then replicates the message and sends the message to endpoints.

According to one embodiment, an endpoint's home location can be resolved by querying a home location registry 115. The home location registry 115 can be a database containing the home message bus 109 address for each endpoint. Because the database should be simple and not regularly updated, the home location registry 115 can be stored in each realm 103 and each home location registry 115 instance can be updated each time one is modified. In another embodiment, each cluster, or a set of clusters can have its own instance of a home location registry 115.

System 100, according to certain embodiments, utilizes a messaging bus 109 to provide efficient communications and services. A messaging bus 109 is a logical component that can connect applications and services running on application platforms 107. The messaging bus 109 transports the messages between applications. The messaging bus 109 uses a messaging scheme that is compatible with each of the applications. Also, the messaging bus 109 can have a set of common message commands and a common infrastructure for sending bus messages to receivers. When using a messaging bus 109, a sender application sends a message to the bus, the messaging bus 109 then transports the message to applications listening to the bus for the message.

Additionally, in certain embodiments, the messaging bus 109 can be associated with a publisher and subscriber messaging model where when a message is published, the message is sent to subscriber nodes. The publisher and subscriber model can include a list-based implementation, a broadcast-based implementation, or a content-based implementation. In a list-based subscription model, a list is maintained of publishing topics/subjects and subscribers/observers and notifying the subscribers/observers when an event occurs. In a broadcast-based model, a message bus 109 broadcasts the message to all of the nodes listening to the message bus 109 and the listening node (subscriber) filters unwanted messages. In the content-based model, when the message bus 109 receives a message, it matches the message against a set of subscribers and forwards the message to the appropriate subscribers. The producers and subscribers can be various applications and services. For example, a music news application in a realm 103 in Arizona can subscribe to a producer news service in a realm 103 in New York. In another example, a music application on a UE 101 can be a producer or subscriber.

In one embodiment, a publisher publishes a message via a channel on the message bus 109. The channel can be created and configured by a message bus 109 endpoint (e.g., a user application 117 or a service running on an application platform 107). The creator of the channel is the owner of the channel. In some embodiments, other users or services may publish or subscribe to the configured channel. Data about the configured channel can be stored in a channel database 111. Each channel database 111 contains publisher information and subscriber information of a channel. In one embodiment, if the channel owner home location is the current cluster, then information about all subscribers is stored in the channel database 111. In another embodiment, if the channel owner home location is a not a specific cluster, the channel database 111 stores only subscriber data for subscribers that have a home location on the specific cluster. This channel database 111 is a proxy channel database specific to the cluster. Thus, channels are set up in a manner so that each cluster has a channel database 111 that contains complete channel data for channels where the owner of the channel is located on the cluster and proxy copies of the channel data specific to the subscribers on the cluster. This improves server storage and utilization and improves scalability of clusters limited by memory usage. In yet another embodiment, a channel is set up in a tree-model hierarchy so that applications and services can structure the channel using custom parameters. Thus a service channel can have sub-channels of news and music, and each of those channels can be customized. In one embodiment, the proxy channel follows the same configuration parameters as the home channel.

In another embodiment, the messaging bus 109 is used to send point-to-point messages within registered message bus 109 endpoints (e.g., a UE 101 or an application platform 107. Point-to-point messages do not use publish-and-subscribe channels to deliver messages, but the messages are routed between the endpoints via the messaging bus 109. For example, an application 117 on a UE 101 may send and receives messages to and from a service by using the messaging bus 109.

An application platform 107a can be used by a UE 101a application 117a to service a user's music, people, places, photo sharing, and other application services needs. In one embodiment, the application platform 107a can be used to access application platforms 107b-107n in different realms 103b-103n; these realms 103b-103n can be geographically dispersed. The application platforms 107b-107n in different realms 103b-103n can carry additional services, such as networks services, games, and video services. Further, services in realm 103a can access the services in realm 103b and realm 103n via a messaging bus 109. Realms 103 can also communicate over a service to service network.

In one embodiment, a realm 103 includes a login handler 121. A client 123 that wishes to send a message can be directed to the login handler 121 to initiate a session. A session is an interactive information exchange between communicating devices that is established at a certain time (e.g., login) and torn down at a later time (e.g., logout). Session information (e.g., identifier, name of applications associated with session, timestamp of the session's creation, etc.) can be stored in a session database 113. The login handler 121 can authenticate a client 123a-123n session.

In one embodiment, the system 100 can be used to multicast a message to multiple endpoints using messaging buses 109, a home location registry 115, and channel databases 111. In one embodiment, a service on an application platform 107a can send a request to a messaging bus 109a to publish a message to subscribers. In another embodiment, a client 123a can request publication of the message. In this embodiment, the client 123a is directed to a local realm 103a by a domain name service (DNS) that resolves the internet protocol address of the client 123a to a rough geographic location that is associated with the realm 103. The client 123a then authenticates using the login handler 121a. Once authenticated, the client 123a requests that the messaging bus 109a send the message to all of the users subscribing to the channel the client 123a wishes to publish to. The messaging bus 109a queries the channel database 111a to determine the subscribers of the channel. In one embodiment, the channel database 111a is on the home cluster of the owner of the channel. In this embodiment, the channel database includes all of the subscribers to the channel (e.g., local subscribers and nonlocal subscribers). The messaging bus 109a then notifies each of the local subscriber endpoints of the message. In some embodiments, the notification includes the message. The messaging bus 109a also determines nonlocal subscriber endpoints. The messaging bus 109a sends the message as well as identifying information to a channel database 111 located on each of the home realms 103 of the nonlocal subscriber endpoints. At a realm 103n of a nonlocal subscriber endpoint, the local messaging bus 109n receives the publication request. The messaging bus 109n queries a channel database 111n to determine the subscribers of the channel. The channel database 111n has a proxy copy of the channel because the owner of the channel does not have a home location on the realm 103. Thus, the channel database 111n has information relevant to the realm 103n. The channel database 111n sends the messaging bus 109n information about the subscribers local to the realm 103n. The messaging bus 109n then sends the subscribers a notification of the message.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet)., or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

By way of example, the UE 101 and an application platform 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

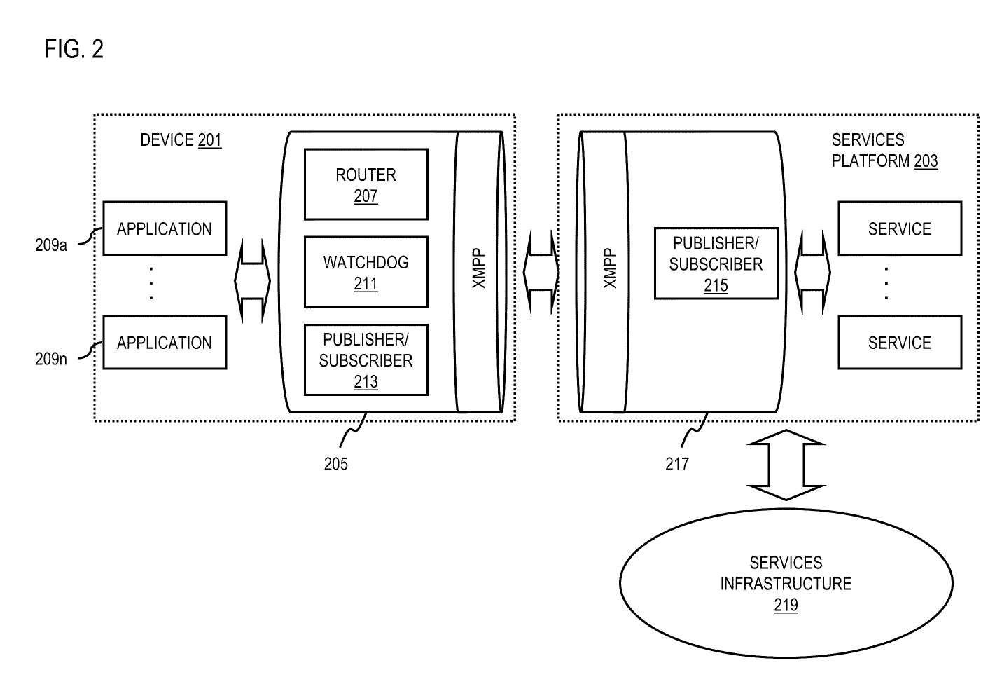

FIG. 2 is a system diagram of messaging buses within user equipment and services platform, according to various embodiments. A device 201, such as UE 101, can communicate with a services platform 203 via a client messaging bus 205. In this example, the device 201 runs applications that use the services provided by the services platform 203. The device 201 can send and receive messages with a services platform 203 through a protocol, such as Extensible Messaging and Presence Protocol (XMPP). In one embodiment, an XMPP core can be associated with the services platform 203. A client device messaging bus 205 can receive XMPP messages and route them by router 207 to the appropriate application 209a -209n. If the application 209 is not running, a watchdog module 211 launches the application 209, passing the message in the launch parameters. In certain embodiments, either the device 201 or the services platform 203 can be the publisher or subscriber 213 and 215. Services can communicate to a server side messaging bus 217 using a Representational State Transfer (REST) Application Programming Interface (API) or messaging bus agents. The services platform 203 can also communicate with a services infrastructure 219 using a REST API or messaging bus agents. The services infrastructure 219 can include enterprise services bus services using a different bus structure. In one embodiment, the messaging bus 109 is located and logically bound into a core XMPP service.

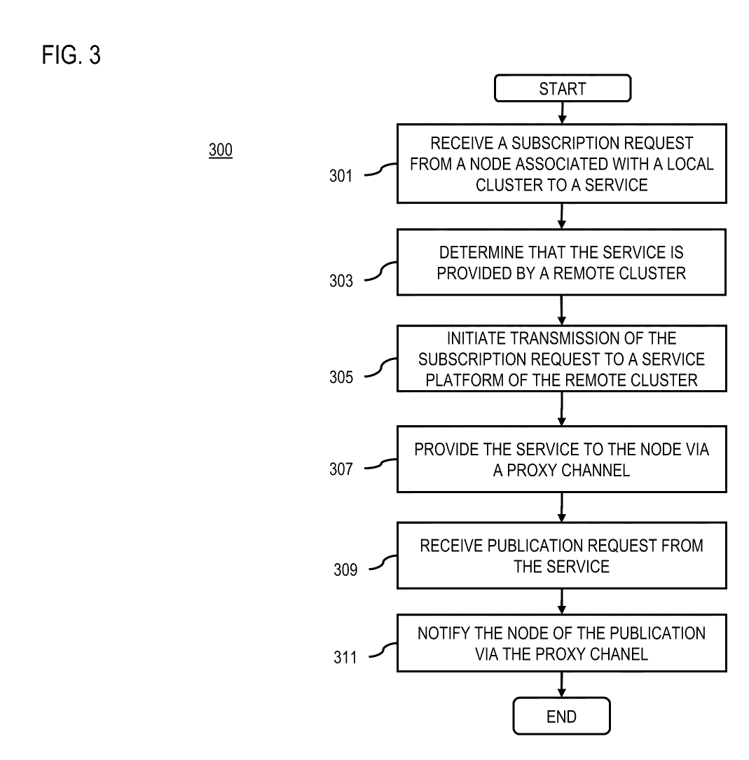

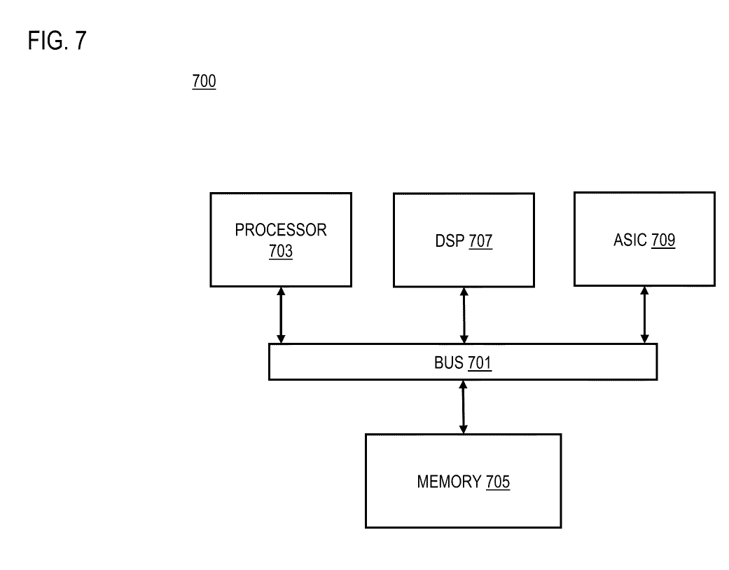

FIG. 3 is a flowchart of a process for efficiently distributing messages to subscribers in multiple geographic locations, according to one embodiment. In one embodiment, the messaging bus 109 performs the process 300 and is implemented in, for instance, a chip set including a processor and a memory as shown FIG. 7. A node (e.g., UE 101, an application platform 107, etc.) connects to a login handler 121 associated with a cluster. In this exemplary embodiment, a UE 101 represents the node. The UE 101 is directed to the login handler 121 by a DNS server associating with a local area corresponding to the UE 101 with the cluster. In one embodiment, this cluster is a local cluster of the UE 101. The UE 101 authenticates with the login handler 121 by providing credentials. The UE 101 then requests to subscribe to a channel provided by a service located on a remote cluster associated with the cluster. At step 301, the messaging bus 109a receives the subscription request to the service from the user equipment 101 within the local cluster.

At step 303, the messaging bus 109a determines that the service is provided by a remote cluster. The messaging bus 109a queries a home location registry 115 to determine the home location of the service. The home location registry 115 returns a notification that the service is provided by the remote cluster.

At step 305, the messaging bus 109a initiates transmission of the subscription request to a service platform of the remote cluster. The service platform receives the subscription request. Next, the service platform, via a remote cluster messaging bus 109n, updates a remote cluster channel database 111n associated with the service to include the UE 101 as a subscriber. The remote cluster messaging bus 109n then sends notification of the subscription to the local cluster messaging bus 109a.

At step 307, the local cluster messaging bus 109a provides the service to the user equipment, a node, via a proxy channel. In one embodiment, there is no local channel associated with the service. Thus, the local cluster messaging bus 109a creates a new proxy channel in a local channel database 111a to provide access to the service. Then, the local cluster messaging bus 109a updates the proxy channel show that the user equipment 101 is subscribed to the channel. In another embodiment, the proxy channel associated with the service already exists and the local cluster messaging bus 109a need not create the proxy channel. In one embodiment, a plurality of local subscribers are associated with the channel information in the local channel database 111a.

At step 309, the local cluster messaging bus 109a receives a publication request from the service via a messaging bus 109n servicing the service. The service sends a request to publish to the channel to the remote cluster messaging bus 109n. The remote cluster messaging bus 109n queries the remote cluster channel database 111n for subscribers to the channel. The remote cluster channel database 111n includes information pertaining to all of the subscribers of the channel. The remote cluster channel database 111n sends information back to the remote cluster messaging bus 109n of the local subscribers and the locations of clusters foreign to the remote cluster with additional subscribers. In one embodiment, the local cluster has subscribers to the service. The remote cluster messaging bus 109n then sends a copy of the message to the local cluster messaging bus 109a and the request to publish the message.

At step 311, the local cluster messaging bus 109a notifies the user equipment, a node, of the publication via the proxy channel. The local cluster messaging bus 109a queries a channel database 111a to determine the local subscribers of the service. The channel database 111a checks the proxy channel associated with the service and returns the local subscribers of the service. In one embodiment, the user equipment 101 is one of a plurality the subscribers. The plurality of subscribers can include service nodes, user equipment nodes, and other endpoints associated with the system 100. The local cluster messaging bus 109a then notifies all of the local subscribers of the publishing event. In one embodiment, the user equipment 101 is notified of the publication. In some embodiments, the notification contains the message. In one embodiment, the notification is a broadcast of the message.

According to the above approach, publishers can efficiently multicast information to subscribers at various geographic locations using a messaging bus 109. In this manner, endpoints (e.g., a user equipment node) can request that a channel for multicasting be created in an efficient manner. Thus, remote proxy channels are not created at a remote location unless an endpoint associated with the remote location requests to be a subscriber. Thus, valuable resources can be saved on the remote location. This also leads to more efficient scalability because only one message need be sent to each remote location for distribution. Then the remote location can efficiently distribute the information to subscribers.

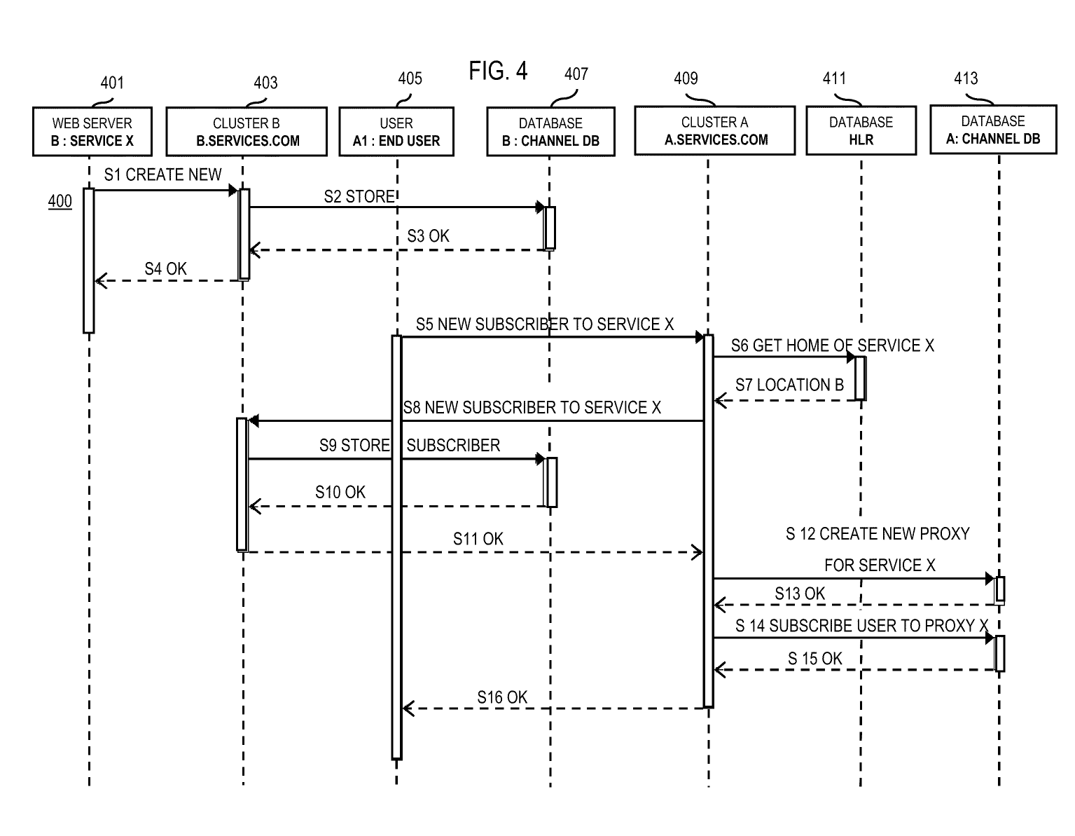

FIG. 4. is a ladder diagram for processes for subscribing endpoints for distributing messages to a multitude of endpoints via clusters in multiple geographic locations, according to one embodiment. In one embodiment, a cluster performs the process 400 and is implemented in, for instance, a chip set including a processor and a memory as shown FIG. 7. In this embodiment, a service associated with a web server node 401 associated with Cluster B 403 wishes to create a channel to multicast information to channel subscribers (e.g., end user 405, an endpoint, etc.). At S1, Cluster B 403 receives a request to create a new channel for the service from the web server node 401. Cluster B 403 then, at S2, instructs a channel database 407 associated with Cluster B to create the channel and store information regarding the channel and the service in the channel database 407. At S3, the channel database 407 notifies Cluster B 403 that the channel was created successfully. Cluster B 403 then, at S4, notifies the service that the channel is ready to use. In some embodiments, the service can send a list of pre-subscribed endpoints to the channel database 405.

In one embodiment, an end user 405 wishes to subscribe to the channel of the service. In this embodiment, the end user 405 is associated with Cluster A 409 that is in a remote location from Cluster B 403. The end user 405 can log into Cluster A 409 using authentication credentials and can be associated as a node of Cluster A 409. At S5, the end user sends a request to Cluster A 409 to become a new subscriber of the channel associated with the service. Then, at S6, Cluster A 409 queries a home location registry 411 to determine the home of the service channel. At S7, the home location registry 411 notifies Cluster A 409 that the home of the service channel is at Cluster B 403. Cluster A 409, at S8, sends a request to Cluster B 403 to subscribe the user 405 to the channel. Cluster B 403, at S9, stores information identifying the end user 405 in the channel associated with the service in the channel database 407 of Cluster B 403. The identification can be a unique identifier used to identify the user in the home location registry 411. The channel database subscribes the end user 405 to the channel. The channel database 407 associated with Cluster B 403 then, at S10, sends a notification to Cluster B 403 of the subscription. Cluster B 403 then notifies Cluster A 409 of the successful request. Once Cluster A 409 receives the successful request acknowledgement, Cluster A 409, requests to subscribe the user to a proxy channel associated with the service on Cluster A 409. In one embodiment, the channel database 413 associated with cluster A 409 does not have a proxy channel for the service. In this embodiment, at S12, Cluster A requests that its channel database 413 create a new proxy channel for the service. The channel database 413 of Cluster A 409 then, at S13, sends a notification to Cluster A 409 of the successful creation of the channel proxy. If there is a proxy channel on Cluster A 409 for the service, then at S14, Cluster A 409 requests that the channel database 413 subscribe the user to the channel proxy. Once completed, the channel database 413 of Cluster A 409 sends an acknowledgement of the successful subscription to Cluster A 409. Cluster A 409 then notifies the user that the user is now successfully subscribed to the requested channel of the service.

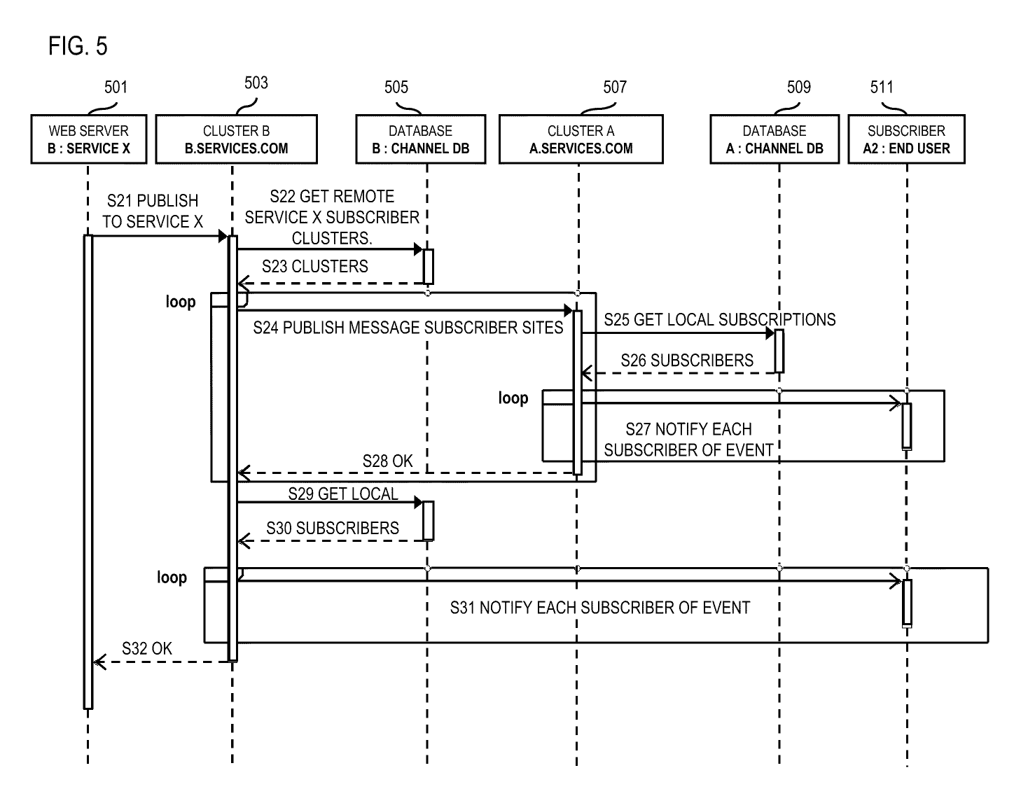

FIG. 5. is a ladder diagram for processes of sending messages to multiple users via clusters in multiple geographic locations, according to one embodiment. In one embodiment, a cluster performs the process 500 and is implemented in, for instance, a chip set including a processor and a memory as shown FIG. 7. At S21, an endpoint (e.g., a service on a web server 501) associated with Cluster B 503 sends a request to Cluster B 503 to publish a request to a channel associated with a service. In one embodiment, Cluster B 503 is the home location of the channel and the channel includes the locations of all subscribers. Cluster B 503 receives the request and, at S22, sends a request to a channel database 505 associated with Cluster B 503 to get the remote subscribers of the channel. In this embodiment, the some subscribers are located at a remote site. At S23, the Cluster B 503 channel database 505 sends the cluster locations associated with the remote subscribers. At S24, Cluster B 503 publishes the message to all of the clusters with residing subscribers.

In one embodiment, Cluster A 507 is a cluster with subscribers to the channel. In one embodiment, Cluster A 507 is in a different geographic location than Cluster B 503. Cluster A 507 receives the publication and a request to publish the message to all subscribers associated with Cluster A 507. At S25, Cluster A 507 sends a request to a Cluster A 507 channel database 509 to look up a proxy channel associated with the service channel and retrieve local subscribers. At S26, Cluster A 507 channel database 509 then sends a list of all of the local subscribers. In one embodiment, the proxy channel only includes local subscribers. This helps save resources by limiting the memory consumption of storing the entire list of subscribers. This also improves efficiency because less of the memory space needs to be queried. At S27, Cluster A 507 notifies each subscriber (e.g., end user 511, a service, a client, etc.) local to Cluster A 507 of the event. In one embodiment, the notification includes delivery of the message. In this embodiment, the message is replicated at Cluster A 507 for delivery. At S28, Cluster A 507 notifies Cluster B 503 that the subscribers have been notified of the publication. In some embodiments, there is no such notification, a notification of the receipt of the publication is sent, or a notification of beginning delivery of the publication to the local subscribers is sent.

In one embodiment, Cluster B 503 receives notification of the successful publication of remote clusters. At S29, Cluster B 503 queries its channel database for local subscribers. In some embodiments, steps S29 to S31 take place before or simultaneously with step S22. At S30, the Cluster B 503 channel database 505 returns local subscribers in response to the query. Then, at S31, Cluster B 503 notifies each subscriber local to Cluster B 503 of the event. In some embodiments, the notification includes publishing the publication message. At S32, Cluster B 503 acknowledges completion of the publications. In some embodiments, there is no such acknowledgement, or an acknowledgement of beginning delivery of the publication to the local subscribers is sent.

With the above approach, a message can be multicast to various global locations in an efficient manner. The approach allows for the efficient routing of information between geographic locations by sending a single instance of the information to a remote location and replicating the information at that location. Additionally, this approach allows for looking up subscribers in an efficient technique by only looking up subscribers local to a specific cluster at a time. This can increase the load efficiency and capacity of the clusters.

The processes described herein for multicasting messages may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

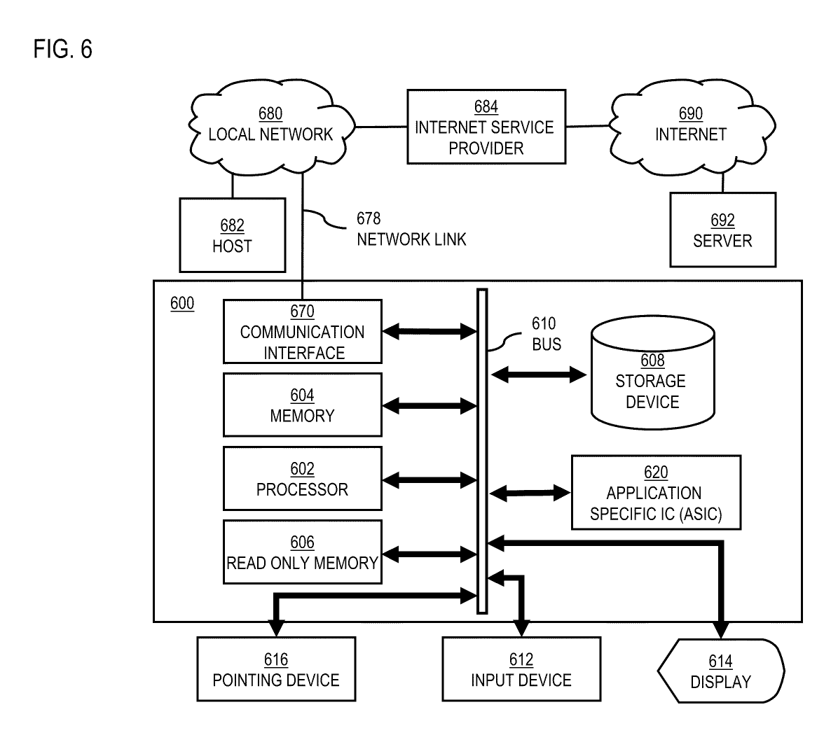

FIG. 6 illustrates a computer system 600 upon which an embodiment of the invention may be implemented. Computer system 600 is programmed (e.g., via computer program code or instructions) to multicast messages as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to multicast messages. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for multicasting messages. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for multicasting messages, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 to the UE 101.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

FIG. 7 illustrates a chip set 700 upon which an embodiment of the invention may be implemented. Chip set 700 is programmed to multicast messages as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to multicast messages over geographic locations. The memory 705 also stores the data associated with or generated by the execution of the inventive steps.

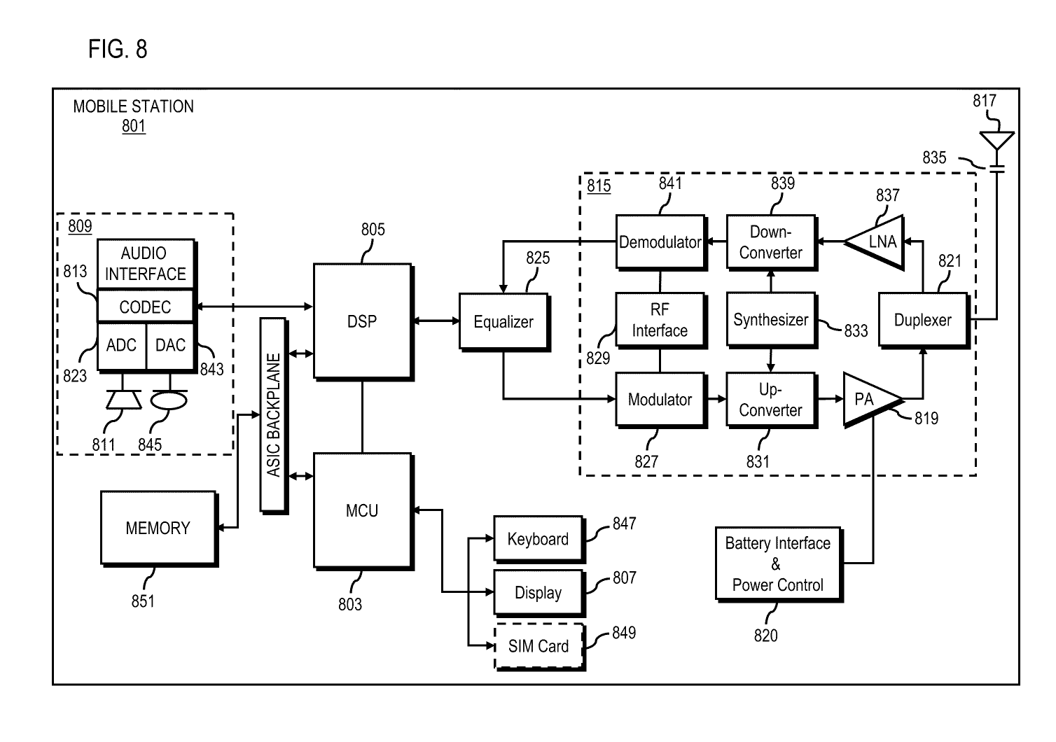

FIG. 8 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions that offer automatic contact matching. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile station 801 to multicast messages. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

The following patent applications are incorporated herein by reference in their entireties: co-pending U.S. Patent Application (NC69499US P2600US00) filed Jun. 18, 2009, entitled “Method and Apparatus for Message Routing Optimization,” and co-pending U.S. Patent Application (NC69561US P2605US00) filed Jun. 18, 2009, entitled “Method and Apparatus for Message Routing to Services.”

What is claimed is:

1. A method comprising:
receiving a subscription request to a service from a node within a local cluster;
determining that the service is provided by a remote cluster;
initiating transmission of the subscription request to a service platform of the remote cluster; and
providing the service to the node via a proxy channel.

2. A method of claim 1, wherein the node is a user equipment.

3. A method of claim 1, further comprising:
subscribing the node to the proxy channel.

4. A method of claim 3, further comprising:
receiving a publication request from the service; and
notifying the node of the publication request via the proxy channel.

5. A method of claim 4, further comprising:
receiving a request from the node for a publication associated with the publication request; and
initiating transmission of the publication.

6. A method of claim 5, further comprising:
determining that the node is subscribed to the proxy channel; and
notifying the node of the publication request via the proxy channel.

7. A method of claim 1, wherein the proxy channel is subscribed to by a plurality of nodes including the node, the method further comprising:
receiving an event from the service; and
initiating multicast of the event to the plurality of nodes.

8. An apparatus comprising:
at least one processor; and
at least one memory including computer program code,
the at least one memory and the computer program code configured to, with the at least one processor, cause the apparatus to perform at least the following,
receive a subscription request to a service from a node within a local cluster,
determine that the service is provided by a remote cluster,
initiate transmission of the subscription request to a service platform of the remote cluster, and
provide the service to the node via a proxy channel.

9. An apparatus of claim 8, wherein the node is a user equipment.

10. An apparatus of claim 8, wherein the apparatus is further caused to subscribe the node to the proxy channel.

11. An apparatus of claim 10, wherein the apparatus is further caused to:
receive a publication request from the service, and
notify the node of the publication request via the proxy channel.

12. An apparatus of claim 11, wherein the apparatus is further caused to:
receiving a request from the node for a publication associated with the publication request, and
initiate transmission of the publication.

13. An apparatus of claim 12, wherein the apparatus is further caused to:
determine that the node is subscribed to the proxy channel, and
notify the node of the publication request via the proxy channel.

14. An apparatus of claim 8, wherein the proxy channel is subscribed to by a plurality of node including the node, the apparatus being further caused to:
subscribe the node to the proxy channel, wherein the proxy channel comprises a plurality of subscribers and wherein subscriber data regarding the plurality of subscribers are stored in a channel database,
receive an event from the service, and
initiate multicast of the event to the plurality of nodes.

15. A computer-readable storage medium carrying one or more sequences of one or more instructions which, when executed by one or more processors, cause an apparatus to perform at least the following:
receive a subscription request to a service from a node within a local cluster,
determine that the service is provided by a remote cluster,
initiate transmission of the subscription request to a service platform of the remote cluster, and
provide the service to the node via a proxy channel.

16. A computer-readable storage medium of claim 15, wherein the node is a user equipment.

17. A computer-readable storage medium of claim 15, wherein the apparatus is further caused to subscribe the node to the proxy channel.

18. A computer-readable storage medium of claim 17, wherein the apparatus is further caused to:
receive a publication request from the service, and
notify the node of the publication request via the proxy channel.

19. A computer-readable storage medium of claim 18, wherein the apparatus is further caused to:
receive a request from the node for a publication associated with the publication request, and initiate transmission of the publication.

20. A computer-readable storage medium of claim 19, wherein the apparatus is further caused to:
determine that the node is subscribed to the proxy channel, and
notify the node of the publication request via the proxy channel.
